(19) United States
(12) Patent Application Publication
(10) Pub. No.: US 2010/0026202 A1
(43) Pub. Date: Feb. 4, 2010

(54) Starting Apparatus for a High-Pressure Discharge Lamp, and a High-Pressure Discharge Lamp with a Starting Apparatus

(75) Inventor: Bernhard Siessegger, Munchen (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM GESELLSCHAFT MIT BESCHRANKTER HAFTUNG, MUNCHEN (DE)

(21) Appl. No.: 12/519,110

(22) PCT Filed: Nov. 28, 2007
(86) PCT No.: PCT/EP07/62944

§ 371 Date: Jun. 12, 2009

(30) Foreign Application Priority Data
Dec. 12, 2006 (DE) 10-2006-058-538.0

(51) Int. Cl. H05B 41/288

(52) U.S. Cl. 315/287

(57) ABSTRACT

A starting apparatus for a discharge lamp (100) comprising a spiral line pulse generator (104) and a charging circuit for charging the spiral line pulse generator, wherein means (108) for rectifying the charging current are arranged in the charging circuit.

The invention relates to a starting apparatus for a discharge lamp which is equipped with a spiral line pulse generator, which generates the starting voltage required for starting the gas discharge in the discharge lamp.

### I. PRIOR ART

Such a starting apparatus has been disclosed, for example, in U.S. Pat. No. 4,325,004 B1 and in U.S. Pat. No. 4,325,012 B1.

U.S. Pat. No. 4,325,004 B1 describes a starting apparatus for a discharge lamp provided with an auxiliary starting electrode, wherein the starting apparatus has a spiral line pulse generator whose high-voltage terminal is connected to the auxiliary starting electrode. The discharge lamp and the starting apparatus are operated on the AC system voltage. A spark gap is connected in parallel with the contacts or terminals of the spiral line pulse generator which are arranged in the charging circuit, and this spark gap breaks down as soon as the charge on the spiral line pulse generator reaches the breakdown voltage of the spark gap.

U.S. Pat. No. 4,325,012 B1 describes a starting apparatus for a high-pressure discharge lamp, wherein the starting apparatus has a spiral line pulse generator whose high-voltage terminal is connected to a gas discharge electrode of the high-pressure discharge lamp. The high-pressure discharge lamp and the starting apparatus are operated on the AC system voltage. A spark gap is connected in parallel with the contacts or terminals of the spiral line pulse generator which are arranged in the charging circuit, and this spark gap breaks down as soon as the charge on the spiral line pulse generator reaches the breakdown voltage of the spark gap.

One disadvantage with the abovedescribed starting apparatuses consists in the fact that they can only be operated on the AC system voltage, which has a comparatively low frequency, and are unsuitable for operation in the radiofrequency range, for example in the megahertz range.

### II. DESCRIPTION OF THE INVENTION

The object of the invention is to provide a starting apparatus of the generic type which is also suitable for radiofrequency operation and to provide a discharge lamp with such a starting apparatus.

This object is achieved according to the invention by the features of claims 1 and 9, respectively. Particularly advantageous embodiments of the invention are described in the dependent claims.

The starting apparatus according to the invention comprises a spiral line pulse generator and a charging circuit for charging the spiral line pulse generator, wherein, according to the invention, means for rectifying the charging current are provided in the charging circuit. The means for rectifying the charging current ensure that the spiral line pulse generator is charged during radiofrequency operation to a voltage which is high enough to be able to generate pulses with a sufficiently high amplitude which make it possible to start the gas discharge in the discharge lamp when the charging contacts of said spiral line pulse generator are short-circuited or when said spiral line pulse generator is discharged. In particular, the abovementioned means for rectifying the charging current ensure that the charging operation of the spiral line pulse generator can extend over a plurality of periods of the radiofrequency AC voltage in the case of radiofrequency operation of the starting apparatus and the discharge lamp. The means for rectifying the charging current of the spiral line pulse generator which are connected into the charging circuit therefore make it possible for the spiral line pulse generator to be capable of being used in radiofrequency operation of the high-pressure discharge lamp (for example at frequencies in the range of from 0.1 MHz to 5 MHz) as a starting pulse generator for generating the starting voltage pulses required for starting the gas discharge in the high-pressure discharge lamp. In addition to the cited frequency range, higher frequencies are also possible, for example operation of the discharge lamp in the ISM bands (Industrial Scientific Medical Bands) at 13.56 MHz and 27.12 MHz. In particular, the high operating frequency allows for operation of the discharge lamp above its acoustic resonances, which is of particular advantage since in this case negative effects as a result of acoustic resonances, such as flicker of the output light or reduced life of the lamp, for example, do not occur. Depending on the size of the lamp, the operating frequency should therefore be selected to be above approximately 300 kHz (for lamps with a high power, for example with a rated power of 250 W) up to approximately 2 MHz (for small lamps, for example with a rated power of 20 W). Advantageously, the means for rectifying the charging current of the spiral line pulse generator comprise at least one diode. Using the at least one diode makes it possible to ensure rectification of the charging current in a simple and inexpensive manner and to achieve a situation in which the charging of the spiral line pulse generator can extend over a plurality of periods of the radiofrequency AC voltage in order to enable sufficient charging of the spiral line pulse generator.

In order to be able to charge the spiral line pulse generator to a higher voltage than the supply voltage provided by the AC voltage source, the means for rectifying the charging current of the spiral line pulse generator advantageously comprise a voltage multiplication circuit, for example a voltage doubling circuit.

The starting apparatus according to the invention is advantageously dimensioned in such a way that it makes a notable contribution to the limiting of the lamp current or to the stabilization of the gas discharge. This applies even in the case of a radiofrequency lamp current at frequencies in the megahertz range, without there being any fear of considerable loads being placed on the electronic component parts of the ballast as a result of the reactance of the starting apparatus. For this purpose, the impedance of the spiral line pulse generator at the operating frequency advantageously has a value of greater than or equal to 0.25 times the value of the lamp impedance.

Preferably, at least one capacitor is connected in series with the spiral line pulse generator. This at least one capacitor provides a plurality of advantages. For the case in which the high voltage, generated by the spiral line pulse generator, is supplied to an auxiliary starting electrode, which is arranged externally on the discharge vessel, of the discharge lamp, the at least one capacitor suppresses diffusion of metal ions from the discharge medium to the discharge vessel wall. In particular, in the case of metal-halide high-pressure discharge lamps, the at least one capacitor prevents the diffusion of sodium ions to the discharge vessel wall and therefore contributes to a reduction in the sodium loss in the discharge medium. For the case in which the high voltage, generated by the spiral line pulse generator, is supplied to a gas discharge electrode, which is arranged in the discharge vessel, of the discharge lamp and, once the gas discharge in the lamp has been started, the radiofrequency lamp current flows via the spiral line pulse generator, the at least one capacitor allows for partial compensation of the inductance of the spiral line pulse generator. Owing to the partial compensation of the inductance of the spiral line pulse generator, the losses in the operating device of the lamp are reduced since the lower effective inductance of the spiral line pulse generator correspondingly results in reduced reactive powers. The at least one capacitor, which is connected in series with the spiral line pulse generator, also prevents a flow of direct current through the discharge lamp and therefore ensures that no segregation of the discharge plasma takes place. In addition, the at least one capacitor, which is connected in series with the spiral line pulse generator, forms a series resonant circuit with the spiral line pulse generator, which, owing to its characteristics by means of a slight frequency variation in the radiofrequency AC voltage provided by the AC voltage source, allows for regulation of the amplitude of the lamp current or of the electrical power injected into the lamp over a wide value range. In particular, the abovementioned series resonant circuit enables the so-called power startup in the case of a metal-halide high-pressure discharge lamp which acts as the light source in a vehicle headlamp. During this power startup, which takes place directly after starting of the gas discharge in the high-pressure discharge lamp, the high-pressure discharge lamp is operated at three to five times its rated power in order to achieve rapid vaporization of the metal halides in the discharge plasma.

In accordance with an exemplary embodiment of the invention, the spiral line pulse generator and the at least one capacitor, which is connected in series with the spiral line pulse generator, are formed as a common component part. This means that the functions of the spiral line pulse generator and of the at least one series-connected capacitor are realized by an integrated component part. This makes it possible to achieve a space-saving arrangement of these two components and both components can be accommodated, for example, in the lamp base or in the interior of the outer bulb of the lamp.

The abovementioned common component part is preferably formed as a ceramic component part in order that it can withstand the high operating temperatures of a high-pressure discharge lamp.

Advantageously, the starting apparatus according to the invention has a switching means for short-circuiting the contacts, which are arranged in the charging circuit, of the spiral line pulse generator in order to enable a sudden discharge of the spiral line pulse generator and therefore the generation of voltage pulses in the spiral line pulse generator.

The abovementioned switching means for short-circuiting the contacts of the spiral line pulse generator is preferably in the form of a threshold value switch, for example in the form of a spark gap, in order to be able to charge the spiral line pulse generator to a sufficiently high voltage such that the voltage pulses generated during the discharge of the spiral line pulse generator can bring about starting of the gas discharge in the high-pressure discharge lamp.

The starting apparatus according to the invention is preferably accommodated in the interior of the lamp base of a discharge lamp or in the outer bulb of a discharge lamp, in particular of a high-pressure discharge lamp, in order to enable a compact design and to avoid lines to the lamp carrying a high voltage.

In order to ensure an arrangement of the starting apparatus in the lamp base which is as space-saving as possible, the spiral line pulse generator is formed as a component part which surrounds that lamp vessel section of the discharge vessel or of an outer bulb of the discharge lamp which protrudes into the lamp base.

### III. DESCRIPTION OF THE PREFERRED EXEMPLARY EMBODIMENT

The invention will be explained in more detail below with reference to preferred exemplary embodiments. In the drawings:

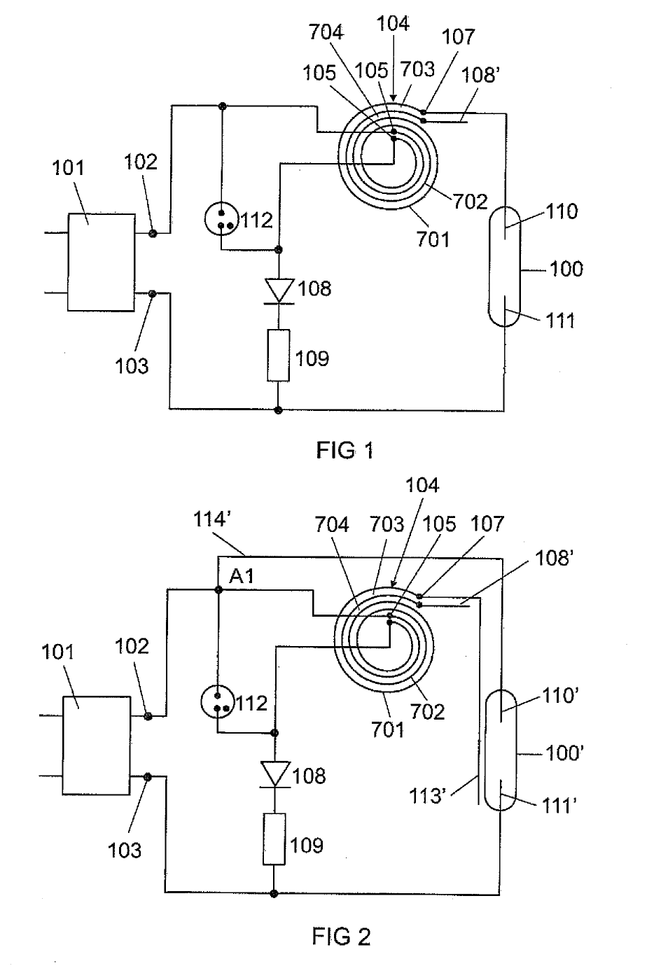

FIG. 1 shows a circuit diagram of the starting apparatus according to the first exemplary embodiment of the invention,

FIG. 2 shows a circuit diagram of the starting apparatus according to the second exemplary embodiment of the invention,

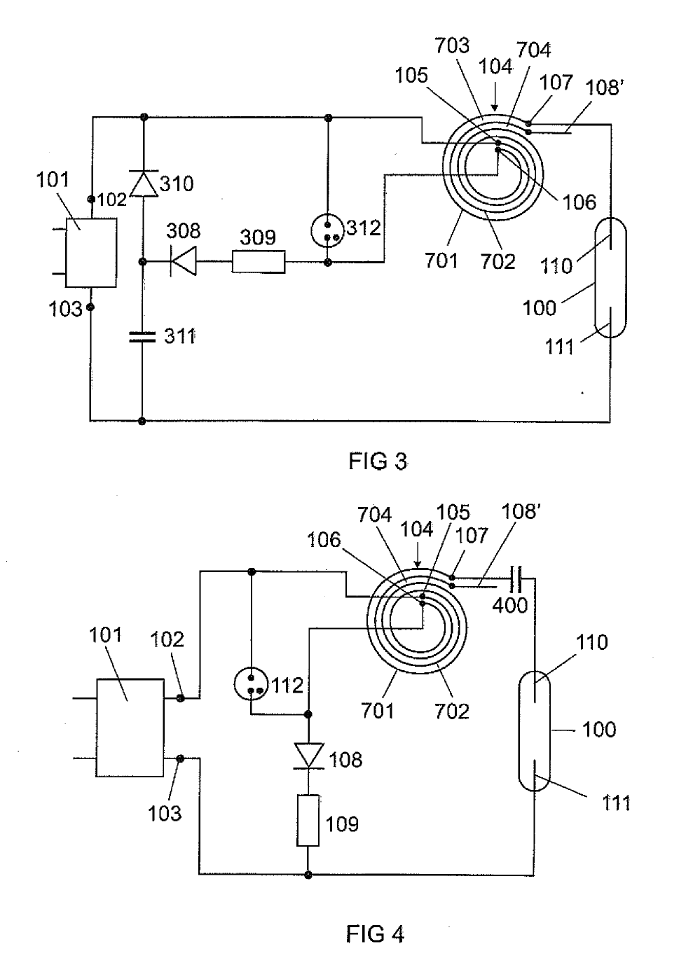

FIG. 3 shows a circuit diagram of the starting apparatus according to the third exemplary embodiment of the invention,

FIG. 4 shows a circuit diagram of the starting apparatus according to the fourth exemplary embodiment of the invention,

FIG. 5 shows a schematic illustration of the circuitry of the spiral line pulse generator and of the compensation capacitor, which are formed as a common ceramic component part, in accordance with the starting apparatus depicted in FIG. 4,

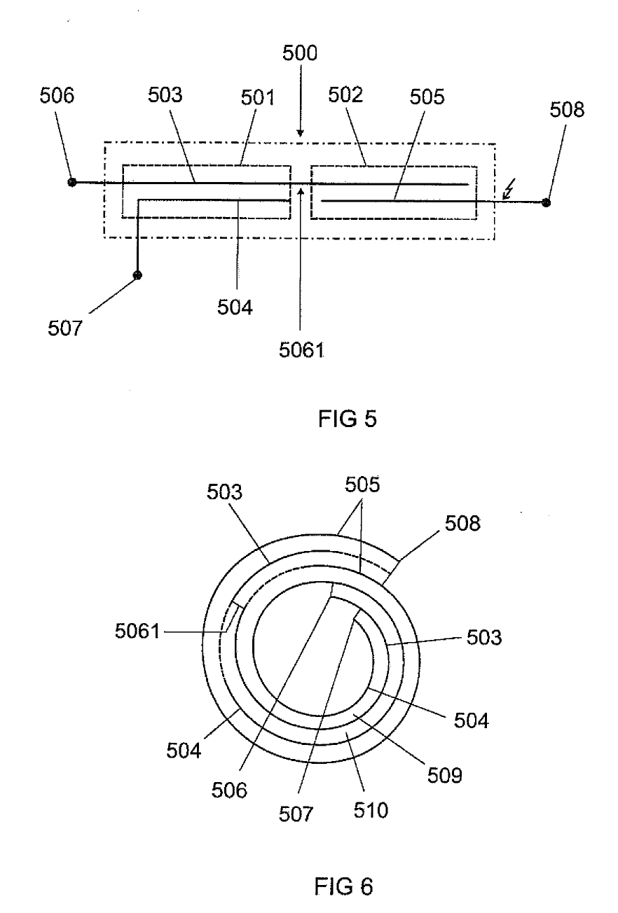

FIG. 6 shows a schematic illustration of the design of the structural unit depicted in FIG. 5 comprising the spiral line pulse generator and the compensation capacitor,

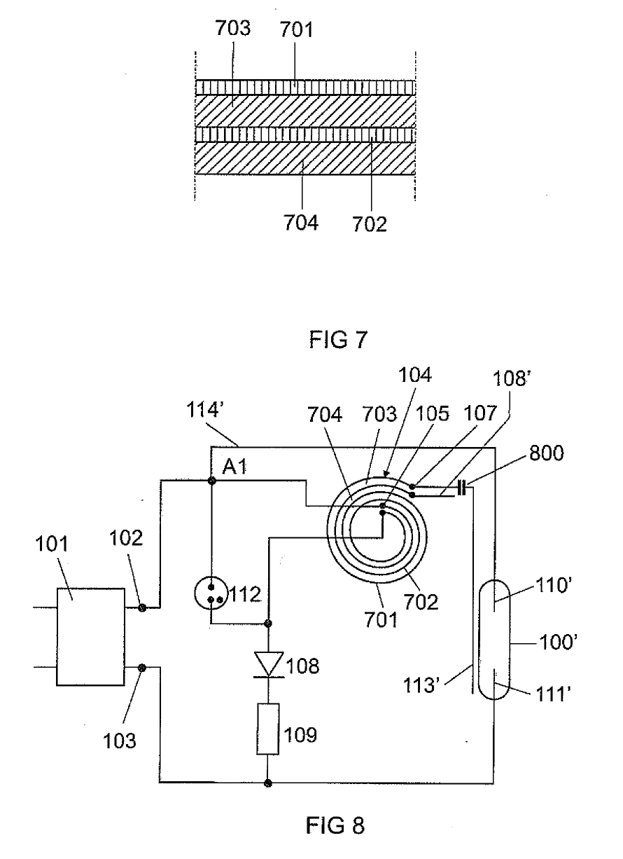

FIG. 7 shows a schematic illustration of the layer sequence of the spiral line pulse generator,

FIG. 8 shows a circuit diagram of the starting apparatus according to the fifth exemplary embodiment of the invention, and

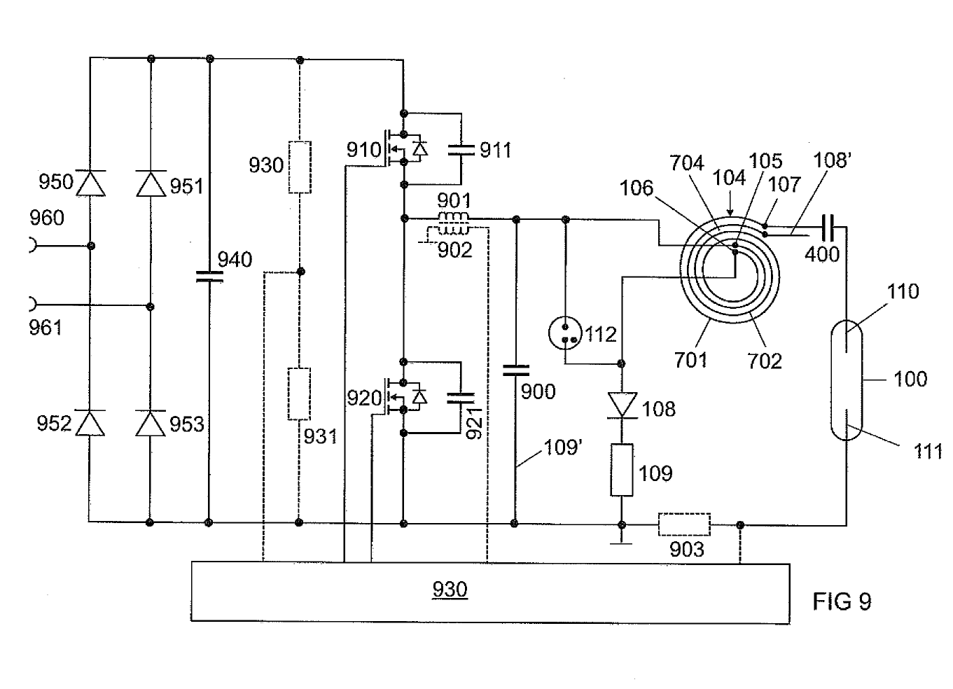

FIG. 9 shows a circuit diagram of the starting apparatus according to the tenth exemplary embodiment of the invention including the operating circuit and the high-pressure discharge lamp.

The circuit diagram of the starting apparatus according to the first exemplary embodiment of the invention illustrated schematically in FIG. 1 is a pulse-operated starting apparatus for a high-pressure discharge lamp, for example for a metal-halide high-pressure discharge lamp, which is used as a light source in a vehicle headlamp or in a projection apparatus. A ballast 101, which generates a radiofrequency output voltage in the frequency range of from approximately 0.1 MHz to 5 MHz, for example, from the motor vehicle electrical system voltage or from the AC system voltage during the starting phase and the subsequent operation of the high-pressure discharge lamp, is used for supplying voltage to the starting apparatus and to the high-pressure discharge lamp 100. A charging circuit for the spiral line pulse generator 104 is connected to the voltage outputs 102, 103 of the ballast 101, in which charging circuit the inner terminals 105, 106 of the spiral line pulse generator 104, a rectifier diode 108 and a resistor 109 are connected. A spark gap 112 is connected in parallel with the two inner terminals 105, 106 of the spiral line pulse generator 104.

The outer terminal 107 of the spiral line pulse generator 104 is connected to a first electrode 110 of the high-pressure discharge lamp 100. As a result, the first electrode 110 is also connected to the output 102 of the ballast 101. The other electrode 111 of the high-pressure discharge lamp 100 is connected to the second voltage output 103 of the ballast 101. The second outer contact 108′ of the spiral line pulse generator 104 is not connected to a component part.

The spiral line pulse generator 104 is substantially a capacitor with a capacitance and an inductance which is not negligible. It comprises two electrical conductors 701, 702, which are arranged in parallel with one another, are wound helically and are separated and insulated from one another by two dielectric layers 703, 704. The two dielectric layers 703, 704 each consist of ceramic, in particular of a so-called LTCC ceramic. The abbreviation LTCC stands for low temperature co-fired ceramic. The electrical conductors 701, 702 consist of silver. The layer thickness of the ceramic layers 703, 704 is preferably in the range of from 30 μm to 60 μm. The ceramic withstands temperatures of up to 800° C. and has a relative permeability of 65. The thickness of the silver layers 701, 702 is preferably in the range of from 1 μm to 17 μm. The number n of turns of the spiral line pulse generator 104 is in the range of from 10 to 20, for example. The inner diameter of the spiral line pulse generator 104 is approximately 20 mm and its height is in the range of from 4 mm to 6 mm, for example. The layer sequence of the spiral line pulse generator 104 is illustrated schematically in FIG. 7. The sandwich structure depicted in FIG. 7 is wound helically and thus results in the spiral line pulse generator 104.

The first electrical conductor 701 has the inner terminal 105 and the outer terminal 107. The other electrical conductor 702 has the inner terminal 106 and the outer contact 108′, which is not used for connecting a component part. The two inner terminals 105, 106 of the spiral line pulse generator 104 are connected into the charging circuit, which is supplied with radiofrequency output voltage of the ballast 101. The radiofrequency charging current for the spiral line pulse generator 104 is rectified by means of the diode 108 and limited by the resistor 109. The charging of the spiral line pulse generator 104 therefore extends over a plurality of periods of the radiofrequency output voltage of the ballast 101. If the charging of the spiral line pulse generator 104 has been continued to such an extent that the breakdown voltage of the spark gap 112 is reached, the spiral line pulse generator 104 is discharged suddenly via the now conductive spark gap 112. As a result, voltage pulses are generated in the spiral line pulse generator 104 and the voltage across the outer terminal 107 increases up to the value 2·n·U₀ if the number of turns of the spiral line pulse generator 104 is denoted by n and the breakdown voltage of the spark gap 112 is denoted by U₀. A voltage is therefore generated at the outer terminal 107 of the spiral line pulse generator 104 which is sufficient for starting the gas discharge in the high-pressure discharge lamp 100. Once the gas discharge in the high-pressure discharge lamp 100 has been started, the charging circuit and also the spark gap 112 are short-circuited by the now conductive discharge path of the high-pressure discharge lamp 100. The radiofrequency discharge current of the high-pressure discharge lamp 100 flows via the terminals 105, 107 through the electrical conductor 701 of the spiral line pulse generator 104. The impedance which can be measured between the terminals 105 and 107 of the spiral line pulse generator 104 can be used for limiting the lamp current or for stabilizing the gas discharge during lamp operation once the gas discharge has been started. This impedance is predominantly inductive owing to the coiled design of the spiral line pulse generator 104. In order to be able to make use of the stabilizing effect of the spiral line pulse generator 104 on the discharge, the spiral line pulse generator 104 is dimensioned in such a way that its impedance at the frequency (or the fundamental) of the lamp current corresponds to 0.25 times to 7 times the impedance of the high-pressure discharge lamp 100. For smaller values of the impedance of the spiral line pulse generator 104, no stabilization of the lamp current flowing via the discharge path of the high-pressure discharge lamp 100 after starting of the gas discharge is generally possible, and for higher values of the impedance of the spiral line pulse generator 104, efficient lamp operation is no longer possible since the ballast 101 then needs to provide a very high output voltage for lamp operation owing to the high reactive power and losses.

In order to dimension the spiral line pulse generator 104 as regards its impedance, the geometrical dimensions and the materials used are selected correspondingly. In order to increase the inductance of the spiral line pulse generator 104, said spiral line pulse generator can surround a material with a high permeability, which passes through the inner diameter of the spiral line pulse generator 104. Thus, a ferrite bar extending through the spiral line pulse generator 104 increases the inductive component of the impedance of the spiral line pulse generator 104 significantly. In addition to a ferrite bar, a ring formed from a U-shaped core and an I-shaped core can also surround the ring-shaped spiral line pulse generator 104, with it being possible to set the impedance by virtue of the air gap between the U-shaped core and the I-shaped core.

The sixth exemplary embodiment described below demonstrates a particularly advantageous embodiment of the first exemplary embodiment, in which the impedance of the spiral line pulse generator 104 stabilizes the gas discharge. For a mercury-free high-pressure discharge lamp 100 with a discharge vessel made from quartz glass and a rated power of 35 W and a rated running voltage of 45 V, and therefore a lamp impedance of approximately 58 ohms, a spiral line pulse generator 104 is used which is represented by a series circuit comprising an inductance of 180 microhenries and a nonreactive resistance of 0.8 ohm. The ballast 100 provides a virtually sinusoidal current with a frequency of 100 kHz, with the result that particularly efficient lamp operation is provided as a result of the low resistive component in the overall impedance of the spiral line pulse generator 104. In this case, the discharge lamp is operated in a so-called frequency window in which there are no negative effects as a result of acoustic resonances.

The seventh exemplary embodiment described below likewise represents a particularly advantageous embodiment of the first exemplary embodiment in which the impedance of the spiral line pulse generator 104 stabilizes the gas discharge and in which the lamp is operated in the range above the acoustic resonances. The mercury-containing high-pressure discharge lamp (100) with a ceramic discharge vessel has a rated power of 20 W and a rated running voltage of 85 V. The spiral line pulse generator 104 is represented by a series circuit comprising an inductance of 16 microhenries and a nonreactive resistance of 2.2 ohms. The ballast 100 provides an approximately sinusoidal current with a frequency of 2.45 MHz, with the result that particularly efficient lamp operation is produced as a result of the low resistive component in the total impedance of the spiral line pulse generator 104. FIG. 2 shows the circuit diagram of a second exemplary embodiment of the starting apparatus according to the invention with a high-pressure discharge lamp 100′ connected. This exemplary embodiment differs from the first exemplary embodiment merely by virtue of the fact that a high-pressure discharge lamp 1001 equipped with an auxiliary starting electrode 113′ is connected to the starting apparatus according to the invention instead of the high-pressure discharge lamp 100. In FIGS. 1 and 2, the same reference symbols are therefore used for identical component parts. The high-pressure discharge lamp 100′ has, in addition to the two gas discharge electrodes 110′, 111′ protruding into the interior of the discharge vessel of the high-pressure discharge lamp 100′, an auxiliary starting electrode 113′, which is arranged outside of the interior surrounded by the discharge vessel and to which the starting voltage pulses are applied for starting the gas discharge in the high-pressure discharge lamp 100′. For this purpose, the outer terminal 107 of the first electrical conductor of the spiral line pulse generator 104 is connected to the auxiliary starting electrode 113′. In order to start the gas discharge in the high-pressure discharge lamp 100′, the spiral line pulse generator 104 is charged to the breakdown voltage of the spark gap 112. When the breakdown voltage of the spark gap 112 is reached, the spiral line pulse generator 104 is discharged, as has already been explained above, as a result of which voltage pulses are generated at the outer terminal 107 of the spiral line pulse generator 104 which are supplied to the auxiliary starting electrode 113′ of the high-pressure discharge lamp 100′ in order to start the gas discharge in the high-pressure discharge lamp 100′. Once the gas discharge has been started in the high-pressure discharge lamp 100′, the charging circuit of the spiral line pulse generator 104 and the spark gap 112 are short-circuited by the now conductive discharge path of the high-pressure discharge lamp 100′. The discharge current of the high-pressure discharge lamp 100′ flows at the node Al into the current path 114′ via the gas discharge electrodes 110′, 111′ of the high-pressure discharge lamp 100′. The spiral line pulse generator 104 has no function once the gas discharge in the high-pressure discharge lamp 100′ has been started.

The abovedescribed lamp with an auxiliary starting electrode 113′, which is arranged outside of the interior surrounded by the discharge vessel, is a lamp with an auxiliary starting electrode capacitively coupled thereto. If the auxiliary starting electrode is coupled in another way, the circuit according to the invention can be applied correspondingly, for example in the case of a lamp with an auxiliary electrode which is DC-coupled thereto, in the case of which the auxiliary starting electrode protrudes as far as into the interior surrounded by the discharge vessel.

FIG. 3 schematically illustrates the circuit diagram of a third exemplary embodiment of the starting apparatus according to the invention. This third exemplary embodiment differs from the first exemplary embodiment by virtue of the fact that a voltage doubling circuit 308, 310, 311 is arranged in the charging circuit of the spiral line pulse generator 104, which voltage doubling circuit provides the doubled, rectified output voltage of the ballast 101 at the inner terminals 105, 106 of the spiral line pulse generator 104. Identical component parts have therefore been provided with the same reference symbols in FIGS. 1 and 3. The voltage doubling circuit comprises the rectifier diodes 308, 310 and the capacitor 311. The voltage doubling circuit 308, 310, 311 is used to generate, from the radiofrequency output voltage which is provided at the terminals 102, 103 of the ballast 101, a DC voltage which is up to twice as high as the amplitude of the output voltage of the ballast 101 at the inner terminals 105, 106 of the spiral line pulse generator 104. As a result, the spiral line pulse generator 104 can be charged to a significantly higher voltage than in the first exemplary embodiment if the breakdown voltage of the spark gap 312 is likewise designed so as to be correspondingly higher. A voltage doubling of the input voltage at the inner terminals 105, 106 of the spiral line pulse generator 104 results in doubling of the starting voltage of the starting voltage pulses which are available at the outer terminal 107 of the spiral line pulse generator 104 for the electrode 110 of the high-pressure discharge lamp 100. The mode of operation of the starting apparatus and the spiral line pulse generator 104 according to the third exemplary embodiment, apart from the voltage doubling, is identical to the mode of operation of the abovedescribed first exemplary embodiment of the starting apparatus according to the invention. In addition to the unbalanced voltage doubling circuit illustrated here, which is also referred to as single-stage cascade circuits, the balanced voltage doubling circuit or alternative multi-stage cascade circuits can be used as the voltage multiplication circuit. The cascade circuits are often also referred to as Cockroft-Walton circuits. FIG. 4 illustrates the circuit diagram of a fourth exemplary embodiment of the starting apparatus according to the invention. This fourth exemplary embodiment differs from the first exemplary embodiment merely by virtue of the fact that a capacitor 400 is connected between the outer terminal 107 of the spiral line pulse generator 104 and the electrode 110 of the high-pressure discharge lamp 100. In all other details the starting apparatuses according to the first and fourth exemplary embodiments correspond to one another. The same reference symbols are therefore used for identical component parts in FIGS. 1 and 4. The capacitor 400 as a good approximation represents a short circuit for the high-voltage pulses generated by the spiral line pulse generator 104 and provided at the terminal 107 for starting the gas discharge in the high-pressure discharge lamp 100. This means that the starting voltage pulse generated is only damped to a small extent and, despite the capacitor 400, the amplitude of the starting pulse at the electrode 110 is more than 70% of the amplitude of the voltage pulse at the terminal 107. The capacitor 400 is used for partial compensation of the inductance of the spiral line pulse generator 104 during lamp operation once the starting phase of the high-pressure discharge lamp 100 has come to an end if the radiofrequency lamp current is flowing through the first conductor 701 of the spiral line pulse generator 104. During the starting phase, the mode of operation of the starting apparatus according to the fourth exemplary embodiment is identical to the abovedescribed mode of operation of the starting apparatus according to the first exemplary embodiment. Once the gas discharge in the high-pressure discharge lamp 100 has been started, a radiofrequency current flows through the electrical conductor 701 of the spiral line pulse generator 104 and via the compensation capacitor 400 and via the discharge path of the high-pressure discharge lamp 100. The inductance of the spiral line pulse generator 104 is used for limiting this current. However, a high inductance, which may be entirely desirable during the starting phase owing to the desirable properties of the spiral line pulse generator which it often entails, causes losses in the ballast during lamp operation once the starting phase has come to an end. The capacitor 400 is therefore connected in series with the conductor 701 of the spiral line pulse generator 104, and the capacitance of said capacitor is dimensioned in such a way that it represents, as a good approximation, a short circuit for the starting voltage pulses during the starting phase and reduces the effective inductance of the spiral line pulse generator 104 through which the lamp current is flowing during the subsequent lamp operation.

In addition, the capacitor 400 prevents a flow of direct current through the discharge lamp and therefore ensures that no segregation of the discharge plasma takes place. The latter scenario would be the case, for example, if the ballast 101 were to substantially comprise a half-bridge circuit, with the voltage output 102 being connected to the center point of the half bridge and the voltage output 103 being connected to the positive or negative supply voltage of the half bridge. In this case, the capacitor 400 has the function of a DC voltage blocking capacitor.

In addition, the capacitor 400, which is connected in series with the spiral line pulse generator, forms a series resonant circuit with the spiral line pulse generator, which series resonant circuit, owing to its characteristic by means of a slight frequency variation of the radiofrequency AC voltage provided by the AC voltage source, enables regulation of the amplitude of the lamp current or the electrical power injected into the lamp over a wide value range. In particular, the abovementioned series resonant circuit enables the so-called power startup in the case of a metal-halide high-pressure discharge lamp, which acts as the light source in a vehicle headlamp. During this power startup, which takes place directly after starting of the gas discharge in the high-pressure discharge lamp, the high-pressure discharge lamp is operated at three times to five times its rated power in order to achieve rapid vaporization of the metal halides in the discharge plasma.

The eighth exemplary embodiment described below represents a particularly advantageous embodiment of the fourth exemplary embodiment using the high-pressure discharge lamp 100 from the seventh exemplary embodiment. In contrast to the seventh exemplary embodiment, however, a spiral line pulse generator 104 which can generate a significantly higher starting voltage of 18 kV is now used. However, this has a significantly higher inductance of 246 microhenries and a nonreactive resistance of 5.5 ohms between the terminals 105 and 107. Efficient operation of the entire system with a lamp current produced by the ballast 101 with a frequency of approximately 2.5 MHz is achieved by means of the compensation capacitor 400 with a capacitance of 30 picofarads. In this case, too, the discharge is stabilized by the starting apparatus. The ninth exemplary embodiment described below represents a particularly advantageous embodiment of the fourth exemplary embodiment using the high-pressure discharge lamp 100 from the sixth exemplary embodiment. In contrast to the sixth exemplary embodiment, a spiral line pulse generator 104 which can generate a significantly higher starting voltage of 25 kV is now used. This has an inductance of 51 microhenries and a nonreactive resistance of 0.8 ohm between the terminals 105 and 107. Efficient operation of the entire system with a lamp current produced by the ballast 101 with a frequency of 1.85 MHz in steady-state operation of the high-pressure discharge lamp is achieved by means of the compensation capacitor (400) with a capacitance of 270 picofarads. In this case, too, the discharge is stabilized by the starting apparatus. In this case, the regulation of the lamp power takes place as in the preceding exemplary embodiment by changing the operating frequency or the frequency of the lamp current which is provided by the ballast 101. After starting, and therefore at the beginning of startup of the lamp, initially three times the rated power is supplied. Within a few seconds, the supplied power is reduced continuously down to the rated power, which takes place by increasing the operating frequency starting from approximately 1.4 MHz to 1.85 MHz.

FIG. 8 illustrates the circuit diagram of a fifth exemplary embodiment of the starting apparatus according to the invention with the high-pressure discharge lamp 100′ connected. This exemplary embodiment differs from the second exemplary embodiment merely by virtue of the fact that the capacitor 800 is connected between the outer terminal 107 of the first electrical conductor of the spiral line pulse generator 104 and the auxiliary starting electrode 112′. The same reference symbols are therefore used for identical component parts in FIGS. 2 and 8. The capacitor 800 suppresses diffusion of metal ions from the discharge medium to the discharge vessel wall. In particular, the capacitor prevents the diffusion of sodium ions to the discharge vessel wall in the case of metal-halide high-pressure discharge lamps and therefore contributes to the reduction in the sodium loss in the discharge medium.

This function of the capacitor 800 is effective in all lamps with an auxiliary starting electrode, in particular those with an auxiliary starting electrode which is coupled capacitively or DC-coupled, irrespective of the fact that a lamp with a capacitively coupled auxiliary starting electrode is illustrated in FIG. 8. The mode of operation of the starting apparatus and the spiral line pulse generator 104 according to the fifth exemplary embodiment, apart from the capacitor 800, is identical to the mode of operation of the abovedescribed second exemplary embodiment of the starting apparatus according to the invention.

The spiral line pulse generator 104 and the compensation capacitor 400 in accordance with the starting apparatus depicted in FIG. 4 can advantageously be formed as a common component part 500. Likewise, the spiral line pulse generator 104 and the capacitor 800 in accordance with the starting apparatus depicted in FIG. 8 can advantageously be formed as a common component part. However, the first mentioned case will be explained in more detail below. FIG. 5 schematically illustrates a circuit diagram of the ceramic component part 500, which contains both the spiral line pulse generator 501 and the compensation capacitor 502. The spiral line pulse generator 501 is in this case not represented as a spiral in order to simplify the circuit diagram. The electrical conductors 503, 504, 505 enclosed in the ceramic dielectric form both the spiral line pulse generator 501 and the compensation capacitor 502. The terminals 506, 507 form the inner terminals of the spiral line pulse generator 501 which are connected into the charging circuit of the starting apparatus for the spiral line pulse generator 501. The electrical conductor 503 belongs both to the spiral line pulse generator 501 and to the compensation capacitor 502. Those sections of the electrical conductor 503 which run in the spiral line pulse generator 501 and in the compensation capacitor 502 are electrically conductively connected to one another via a so-called via 5061. The terminal 508 of the compensation capacitor 502 forms the high-voltage output of the ceramic component part 500, which is connected to the electrode 110 or to the auxiliary starting electrode 113′ of the high-pressure discharge lamp 100 or 100′, respectively.

FIG. 6 schematically illustrates a cross section through the ceramic component part 500. In contrast to FIG. 5, FIG. 6 also schematically illustrates the spiral shape. In addition, in FIG. 6 the ceramic layers 509, 510 acting as the dielectric and the via 5061 are illustrated, in addition to the electrical conductors 503, 504, 505. The dielectric ceramic layers 509, 510 and the electrical conductors 503, 504, 505 form a sandwich structure as illustrated in FIG. 7, which is wound in the form of a spiral. The ceramic layers 509, 510 consist of an LTCC ceramic and the electrical conductors 503, 504, 505 and the via 5061 consist of silver. The via 5061 is an aperture in the ceramic dielectric filled with silver. Instead of a via, another type of connection between the corresponding points, within the two dielectric ceramic layers which have been rolled up to form a coil and have correspondingly been metal-plated, can also be provided. The electrical conductors 503, 504, 505 which have been bent in the form of spirals are illustrated by continuous lines in FIG. 6.

The dashed lines running in spiral form in FIG. 6 show regions in which there is no metal conductor arranged between the ceramic layers 509, 510. In the schematic illustration in FIG. 6, only a few turns of the spirals of the spiral line pulse generator 501 and of the compensator capacitor 502, which is in the form of a wound capacitor are depicted for reasons of clarity.

FIG. 9 illustrates the circuit diagram of the tenth exemplary embodiment, which describes a compact arrangement of the entire system which also comprises, in addition to the gas discharge lamp and the starting apparatus according to the invention, the electronic control gear including the control unit. This tenth exemplary embodiment is identical to that in FIG. 4, but a particularly advantageous configuration of the ballast 101 is also disclosed. The same reference symbols are therefore used for identical component parts in FIGS. 4 and 9. The tenth exemplary embodiment uses the same high-pressure discharge lamp 100 with ceramic discharge vessel and a rated power of 20 W as in the seventh exemplary embodiment. The electronic control gear is fed a system voltage of 230 V and 50 Hz at the two input terminals 960 and 961. The system voltage is rectified by means of the diodes 950, 951, 952 and 953 and charges the intermediate circuit capacitor 940. This is used to operate the lamp 100 via a half-bridge circuit. The half-bridge circuit comprises the two MOS switching transistors 910 and 920 which are driven in complementary fashion and whose drain-source paths are each used to connect a capacitor 911 and 921, respectively. Zero voltage switching (ZVS) of the transistors is possible by means of the capacitors 911 and 921. Two complementary types, implemented as field effect or bipolar transistors, can also be used for the two transistors 910 and 920 instead of two identical MOSFETs. The half-bridge center point is connected to the inductor 901 with an inductance of 12 microhenries. This inductor is connected in series with the starting capacitor 900, with a capacitance of 39 picofarads, and in series with the terminal 105 of the spiral line pulse generator 104. The inductor 901 forms, together with the capacitor 900, a series resonant circuit during starting, which series resonant circuit generates a high AC voltage which is used by the diode 108 for charging the spiral line pulse generator 104. During starting, the switching transistors of the half bridge are driven at a frequency close to the steady-state operating frequency of 2.45 MHz. The half-bridge signal supplied to the inductor 901 contains harmonics, with the result that the resonant circuit of three times the operating frequency is excited. Starting takes place by means of the spiral line pulse generator 104, which is represented by a series circuit comprising an inductance of 40 microhenries and a nonreactive resistance of 6 ohms. After starting, the lamp is operated via the compensation capacitor 400 with a capacitance of 150 picofarads, which in addition prevents a direct current through the high-pressure discharge lamp 100. The regulation of the lamp power after starting takes place by varying the switching frequency of the two switching transistors 910 and 920 by the control unit 930. In the steady state, the two switching transistors are driven at a frequency of 2.45 MHz. For regulation and monitoring purposes, the control unit can obtain information from the control gear and via the lamp by means of the electrical connections and components illustrated in dashed lines: the intermediate circuit voltage can be detected by means of the voltage divider comprising the two resistors 930 and 931. Extending the inductor 901 by means of the winding 902 to form a transformer provides further information. Inter alia, a freely-oscillating or self-oscillating operation of the half-bridge circuit is also thus possible. In addition, the lamp current can be detected by the shunt resistor 903. The starting capacitor 900, the spiral line pulse generator 104 and the compensation capacitor 400 are formed as a common ceramic component part. In this embodiment, part of the ballast, namely the starting capacitor 900, is therefore provided by the ceramic component part used in the starting apparatus. This design is provided in similar fashion to that illustrated in FIGS. 5 and 6, as has already been described above. The ceramic component has the terminals 109′, 105, 106, 107 and 108′. The inner terminals are in this case passed out of the coil to the side. The connection of enclosed electrical conductors can take place by means of vias in the coil or else via the terminals of the electrical conductors which are passed out to the side.

In addition to the described embodiments, an embodiment of the starting capacitor (900) and of the spiral line pulse generator (104) in a ceramic component is also possible. Likewise, an embodiment of the starting capacitor (900), of the spiral line pulse generator (104) and of the capacitor (800) in series with an auxiliary electrode is possible in the case of a lamp with an auxiliary electrode.

The starting apparatus according to the invention is preferably accommodated in the base of a high-pressure discharge lamp, for example a metal-halide high-pressure discharge lamp, which is provided as the light source for a motor vehicle headlamp. Such a metal-halide high-pressure discharge lamp for the starting apparatuses shown in FIGS. 1, 3 and 4 is disclosed, for example, in EP 0 975 007 A1, and such a metal-halide high-pressure discharge lamp with an auxiliary starting electrode for the starting apparatus shown in FIGS. 2 and 8 is described, for example, in WO 98/18297 A1. The inner diameter of the spiral line pulse generator 104 or 501 is preferably greater than the outer diameter of the discharge vessel or of the outer bulb of the metal-halide high-pressure discharge lamps disclosed in the abovementioned laid-open specifications. As a result, a space-saving arrangement of the spiral line pulse generator 104 in the base of these metal-halide high-pressure discharge lamps is possible, namely in such a way that the spiral line pulse generator 104 surrounds that end section of the outer bulb and/or of the discharge vessel which protrudes into the lamp base in the form of a ring. The starting apparatus according to the invention is particularly advantageous for radiofrequency operation of these metal-halide high-pressure discharge lamps.

In addition, the starting apparatus according to the invention can preferably be accommodated in the outer bulb of a high-pressure discharge lamp, for example of a metal-halide or sodium high-pressure discharge lamp, which is used as the light source for general lighting.

1. A starting apparatus for a discharge lamp comprising a spiral line pulse generator and a charging circuit for charging the spiral line pulse generator, wherein means for rectifying the charging current are arranged in the charging circuit.

2. The starting apparatus as claimed in claim 2, wherein the means for rectifying the charging current comprise at least one diode.

3. The starting apparatus as claimed in claim 1, wherein the means for rectifying the charging current comprise a voltage multiplication circuit.

4. The starting apparatus as claimed in claim 1, wherein at least one capacitor is connected in series with the high-voltage output of the spiral line pulse generator or in series with the input of the spiral line pulse generator.

5. The starting apparatus as claimed in claim 4, wherein the at least one capacitor (502, 900) and the spiral line pulse generator are formed as a common component part.

6. The starting apparatus as claimed in claim 5, wherein the component part is in the form of a ceramic component part.

7. The starting apparatus as claimed in claim 1, comprising a switching means for short-circuiting the contacts of the spiral line pulse generator which are arranged in the charging circuit or for discharging the spiral line pulse generator.

8. The starting apparatus as claimed in claim 7, wherein the switching means is in the form of a threshold value switch.

9. The starting apparatus as claimed in claim 1, wherein the impedance of the spiral line pulse generator at the operating frequency has a value of greater than or equal to 0.25 times the value of the lamp impedance.

10. A discharge lamp with a lamp base and a starting apparatus as claimed in claim 1 arranged in the lamp base.

11. The discharge lamp as claimed in claim 10, wherein the discharge lamp has a lamp vessel with a lamp vessel section protruding into the lamp base, and the spiral line pulse generator is formed as a component part which surrounds the lamp vessel section.
